(19) United States
(12) Patent Application Publication
(10) Pub. No.: US 2012/0093107 A1
(43) Pub. Date: Apr. 19, 2012

(54) APPARATUS AND METHOD FOR DYNAMICALLY ALLOCATING RESOURCES IN COMMUNICATION SYSTEM

(75) Inventors: Su-Ryong Jeong, Yongin-si (KR); Jae-Weon Cho, Seongnam-si (KR); Hyun-Kyu Yu, Yongin-si (KR); Chi-Woo Lim, Suwon-si (KR)

(73) Assignee: SAMSUNG ELECTRONICS CO., LTD., Suwon-si (KR)

(21) Appl. No.: 13/274,096

(22) Filed: Oct. 14, 2011

(30) Foreign Application Priority Data
Oct. 18, 2010 (KR) 10-2010-0101281

(51) Int. Cl. H04W 72/04

(52) U.S. Cl. 370/329

(57) ABSTRACT

An apparatus and method dynamically allocate resources in a communication system. An operation method of a base station (BS) dynamically allocates resources in a network associated with a first communication system and a second communication system. The method includes, in a start position of a subframe within a frame of the second communication system, generating information on a following subframe for the second communication system's subframe existing in the start position, in a frame structure that supports the coexistence of the first communication system and the second communication system. The method also includes inserting the generated information on the following subframe into a control signal transmitted through a predefined region within the second communication system's subframe existing in the start position and transmitting the control signal to a mobile station associated with the second communication system.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Oct. 18, 2010 and assigned Serial No. 10-2010-0101281, the contents of which are herein incorporated by reference.

### TECHNICAL FIELD OF THE INVENTION

The present invention relates to an apparatus and method for dynamically allocating resources in a communication system. More particularly, the present invention relates to an apparatus and method for dynamically allocating a first communication system's subframe and a second communication system's subframe in a frame structure supporting the coexistence of a first communication system (e.g., an Institute Electrical and Electronics Engineers (IEEE) 802.16e communication system) and a second communication system (e.g., an IEEE 802.16m communication system).

### BACKGROUND OF THE INVENTION

In Fourth Generation (4G) communication systems, which are next generation communication systems, intensive research is being conducted to provide users with services of various Qualities of Service (QoS) at a data rate of about 100 Mega bit per second (Mbps). In particular, a study of 4 G communication systems is now being made to support high-speed services to ensure mobility and QoS for a Broadband Wireless Access (BWA) communication system such as a Wireless Local Area Network (WLAN) system and a Wireless Metropolitan Area Network (WMAN) system. In the following description, a communication system approaching the next generation communication system is called a first communication system. The first communication system is, for example, an IEEE 802.16e based communication system, and can include a Wireless Broadband (WiBro) communication system and the like.

At present, the first communication system has achieved a commercialization level, and a second communication system that is an evolution of the first communication system is under research. The second communication system is, for example, an IEEE 802.16m based communication system, and can include a mobile Worldwide Interoperability for Microwave Access (WiMAX) communication system and the like.

Assuming that the first communication system and the second communication system are realized, the first communication system and the second communication system should be able to coexist. Accordingly, there is a need, in a frame structure that supports the coexistence of a first communication system and a second communication system, for dividing each subframe and efficiently allocating the divided subframe to a first communication system's signal and a second communication system's signal.

### SUMMARY OF THE INVENTION

To address the above-discussed deficiencies of the prior art, it is a primary object to provide at least the advantages below. Accordingly, one aspect of the present invention is to provide an apparatus and method for dynamically allocating resources in a communication system.

Another aspect of the present invention is to provide an apparatus and method in which a Base Station (BS) dynamically divides a first communication system's subframe and a second communication system's subframe and provides a Mobile Station (MS) with information on a frame configuration changed according to the dynamic division, in a frame structure that supports the coexistence of a first communication system (e.g., an Institute Electrical and Electronics Engineers (IEEE) 802.16e communication system) and a second communication system (e.g., an IEEE 802.16m communication system).

A further aspect of the present invention is to provide an apparatus and method in which a BS inserts a subframe indicator of one bit into a control signal transmitted through a predefined region (i.e., an Advanced-MAP (A-MAP) region) within a subframe for the second communication system (e.g., IEEE 802.16m communication system), and informs an MS if the following subframe is the second communication system's subframe.

Yet another aspect of the present invention is to provide an apparatus and method in which a 135 inserts a subframe indicator of more than one bit into a control signal transmitted through a predefined region (i.e., an A-MAP region) within a subframe for the second communication system (e.g., IEEE 802.16m communication system), and informs an MS of the number of the second communication system's subframes among the following subframes.

The above aspects are achieved by providing an apparatus and method for dynamically allocating resources in a communication system.

According to one aspect of the present invention, an operation method of a BS for dynamically allocating resources in a network associated with a first communication system and a second communication system is provided. The method includes, in a start position of a subframe within a frame of the second communication system, generating information on a following subframe for the second communication system's subframe existing in the start position, in a frame structure that supports the coexistence of the first communication system and the second communication system. The method also includes inserting the generated information on the following subframe into a control signal transmitted through a predefined region within the second communication system's subframe existing in the start position, and transmitting the control signal to a mobile station (MS) associated with the second communication system.

According to another aspect of the present invention, an operation method of a second communication system's MS configured to receive dynamic allocation of resources in a network associated with a first communication system and a second communication system is provided. The method includes receiving a second communication system's subframe existing in a start position of a second communication system's subframe within a frame, in a frame structure that supports the coexistence of the first communication system and the second communication system. The method also includes extracting information on the following subframe from a control signal transmitted through a defined region within the received second communication system's subframe.

According to a further aspect of the present invention, an apparatus of a BS for dynamically allocating resources in a network associated with a first communication system and a second communication system is provided. The apparatus includes a scheduler, a message generator, and a Radio Frequency (RF) transmitter. The scheduler is configured, in a start position of a subframe within a frame of the second communication system, to generate information on a following subframe for the second communication system's subframe existing in the start position, in a frame structure that supports the coexistence of the first communication system and the second communication system. The message generator is configured to insert the generated information on the following subframe into a control signal transmitted through a predefined region within the second communication system's subframe existing in the start position. The RF transmitter is configured to transmit the control signal into which the information on the following subframe is inserted, to a Mobile Station (MS) associated with the second communication system

According to yet another aspect of the present invention, an apparatus of a second communication system's MS for receiving dynamic allocation of resources in a network associated with a first communication system and the second communication system is provided. The apparatus includes an RF receiver and a message analyzer. The RF receiver is configured to receive a subframe of the second communication system existing in a start position of a subframe within a frame of the second communication system, in a frame structure that supports the coexistence of the first communication system and the second communication system. The message analyzer is configured to extract information on the following subframe from a control signal transmitted through a defined region within the received second communication system's subframe.

Exemplary embodiments of the present invention have an advantage of making various dynamic subframe allocation real-time adaptive to scheduling, a ratio between respective communication system MSs, a channel environment or the like possible every frame, by allowing a BS to dynamically divide a first communication system's subframe and a second communication system's subframe and provide an MS with information on a frame configuration changed according to the dynamic division, in a frame structure that supports the coexistence of a first communication system (e.g., an IEEE 802.16e communication system) and a second communication system (e.g., an IEEE 802.16m communication system). For example, in one embodiment, a 16m subframe is precedent allocated and, following this, a 16e subframe is allocated, and another embodiment where, following a 16e subframe, a 16m subframe is allocated and, again following this, a 16e subframe is allocated and the like. So, the present invention can obtain an effect of performance improvement of a system transfer rate. Also, the BS provides information on a frame configuration changed according to dynamic division to an MS through a subframe indicator within a corresponding subframe, so the BS can flexibly change a ratio of 16e/16m subframes within a frame at quicker periods without needing to, whenever there is a change of a ratio of 16e/16m subframes within a frame, provide an MS with an updated Frame Configuration Index (FCI).

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an example diagram illustrating a method in which a Base Station (BS) dynamically divides a 16e subframe and a 16m subframe and provides a Mobile Station (MS) with information on a frame configuration that is changed according to the dynamic division, in a frame structure that supports the coexistence of a 16e communication system and a 16m communication system according to a first embodiment of the present invention;

FIG. 2 is an example diagram illustrating a method in which a BS dynamically divides a 16e subframe and a 16m subframe and provides an MS with information on a frame configuration that is changed according to the dynamic division, in a frame structure that supports the coexistence of a 16e communication system and a 16m communication system according to a second embodiment of the present invention;

FIG. 3 is a flowchart illustrating an operation method of a BS in which the BS dynamically divides a 16e subframe and a 16m subframe and provides an MS with information on a frame configuration that is changed according to the dynamic division, in a frame structure that supports the coexistence of a 16e communication system and a 16m communication system according to the present invention;

FIG. 4 is a flowchart illustrating an operation method of a 16m MS in which a BS dynamically divides a 16e subframe and a 16m subframe and provides the 16m MS with information on a frame configuration that is changed according to the dynamic division, in a frame structure that supports the coexistence of a 16e communication system and a 16m communication system according to a first embodiment of the present invention;

FIG. 5 is a flowchart illustrating an operation method of a 16m MS in which a BS dynamically divides a 16e subframe and a 16m subframe and provides the 16m MS with information on a frame configuration that is changed according to the dynamic division, in a frame structure that supports the coexistence of a 16e communication system and a 16m communication system according to a second embodiment of the present invention;

FIG. 6 is an example diagram illustrating a frame configuration and indexing table according to the present invention;

FIG. 7 is a block diagram illustrating an apparatus of a BS in a communication system according to the present invention; and

FIG. 8 is a block diagram illustrating an apparatus of a 16m MS in a communication system according to the present invention.

### DETAILED DESCRIPTION OF THE INVENTION

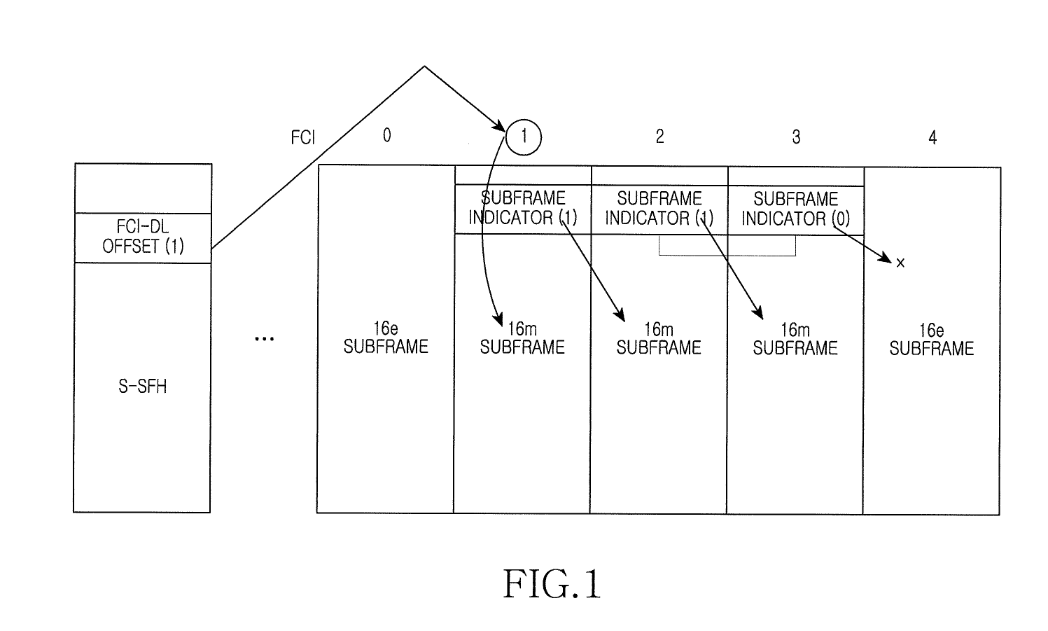

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system. Preferred embodiments of the present invention will be described herein below with reference to the accompanying drawings. In the following description, well-known functions or constructions are not described in detail since they would obscure the invention in unnecessary detail. Terms described below, which are defined considering functions in the present invention, can be different depending on user and operator's intention or practice. Therefore, the terms should be defined on the basis of the disclosure throughout this specification.

Below, exemplary embodiments of the present invention provide methods for dynamically allocating resources in a communication system. Particularly, the exemplary embodiments of the present invention provide methods in which a Base Station (BS) dynamically divides a subframe for transmission/reception of a first communication system's signal and a subframe for transmission/reception of a second communication system's signal and provides a Mobile Station (MS) with information on a frame configuration that is changed according to the dynamic division, in a frame structure that supports the coexistence of a first communication system and a second communication system.

In the following description, a description is, for example, made for a embodiment where an Institute Electrical and Electronics Engineers (IEEE) 802.16e communication system (i.e., a first communication system) and an IEEE 802.16m communication system (i.e., a second communication system) share the same frame, but it will be understood that the description is applicable to other embodiments where different communication systems share the same frame.

Also, in the following description, an MS transmitting/receiving, an IEEE 802.16e communication system's signal is called a 16e MS, and an MS transmitting/receiving an IEEE 802.16m communication system's signal is called a 16m MS. Also, a subframe allocated for transmission/reception of an IEEE 802.16e communication system's signal is called a 16e subframe, and a subframe allocated for transmission/reception of an IEEE 802.16m communication system's signal is called a 16m subframe.

In a frame structure that supports the coexistence of a 16e communication system and a 16m communication system, like a frame structure that supports only a 16e communication system, a 16e MS identifies an allocated position of its own DownLink (DL) signal from a DL-MAP within a frame and receives a DL signal in a corresponding position, thereby performing a 16e DL operation. In contrast, a 16m MS first recognizes a position of a 16m subframe within a frame in order to perform a 16m DL operation in a frame structure that supports the coexistence of a 16e communication system and a 16m communication system. That is, after the 16m MS first identifies a position of a 16m subframe within a frame and receives a 16m subframe in a corresponding position, the 16m MS identifies a DL Advanced MAP (DL-A-MAP) within the received 16m subframe, identifies an allocated position of its own DL signal, and receives a DL signal in a corresponding position. In the present invention, a description is made for a method for generating a subframe indicator so that a 16m MS can identify a position of a 16m subframe within a frame, and transmit the generated subframe indicator to the 16m MS through a control channel within the 16m subframe.

FIG. 1 is an example diagram illustrating a method in which a BS dynamically divides a 16e subframe and a 16m subframe and provides an MS with information on a frame configuration that is changed according to the dynamic division, in a frame structure that supports the coexistence of a 16e communication system and a 16m communication system according to a first embodiment of the present invention.

Referring to FIG. 1, a SubPackect1 (SP1) of a Secondary-Super Frame Header (S-SFH) within a frame includes a Frame Configuration Index (FCI) value. The FCI value corresponds to a DL Offset value representing a start position of a 16m subframe to be allocated to a 16m MS within a frame. For example, as in FIG. 1, an FCI value ‘1’ transmitted to a 16m MS through the SP1 of the S-SFH means that a 16m subframe starts from subframe 1. In detail, the FCI value ‘1’ means that subframe 0 is a 16e subframe, but subframe 1 is the 16m subframe.

According to a distribution ratio of 16e/16m subframes within a frame through scheduling of a BS, a subframe indicator of one bit that indicates if the following one frame is a 16m subframe is inserted into each of control channels (i.e., A-MAP) of all 16m subframes within a frame from a position where the 16m subframe starts. In an embodiment where the following one subframe also is a 16m subframe, a subframe indicator can be set to a value of ‘1’. In an embodiment where the following subframe is not a 16m subframe (i.e., is a 16e subframe), a subframe indicator can be set to a value of ‘0’.

For instance, as in FIG. 1, if a subframe indicator within subframe 1 of a position where a 16m subframe starts is set to a value of ‘1’, this indicates that the following subframe (i.e., subframe 2) also is a 16m subframe. Likewise, if a subframe indicator within subframe 2 is again set to a value of ‘1’, this indicates that the following subframe (i.e., subframe 3) also is a 16m subframe. Lastly, if a subframe indicator within subframe 3 is set to a value of ‘0’, this indicates that the following subframe (i.e., subframe 4) is a 16e subframe.

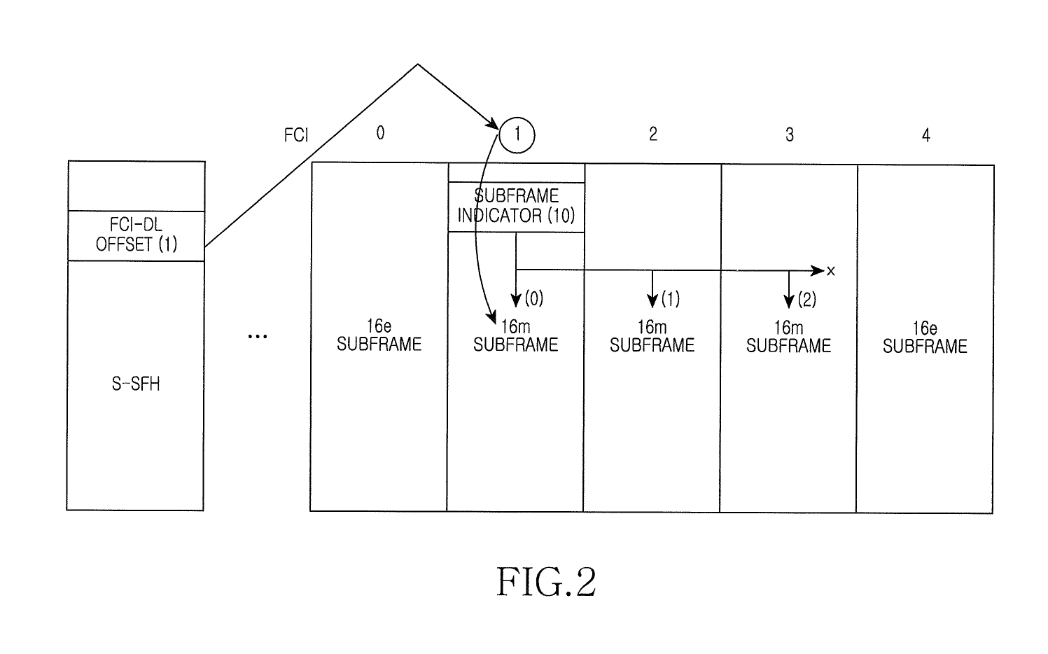

FIG. 2 is an example diagram illustrating a method in which a BS dynamically divides a 16e subframe and a 16m subframe and provides an MS with information on a frame configuration that is changed according to the dynamic division, in a frame structure that supports the coexistence of a 16e communication system and a 16m communication system according to a second embodiment of the present invention.

Referring to FIG. 2, an SP1 of an S-SFH within a frame includes an FCI value. As mentioned earlier, the FCI value corresponds to a DL Offset value representing a start position of a 16m subframe to be allocated to a 16m MS within a frame. For example, as in FIG. 2, an FCI value ‘1’ transmitted to a 16m MS through the SP1 of the S-SFH means that a 16m subframe starts from subframe 1. In detail, the FCI value ‘1’ means that subframe 0 is a 16e subframe, but subframe 1 is the 16m subframe.

According to a distribution ratio of 16e/16m subframes within a frame through scheduling of a BS, a subframe indicator of ‘N’ bits (e.g., more than one bit) that indicate the number of 16m subframes among the following subframes is inserted into a control channel (i.e., A-MAP) of a 16m subframe of a position where the 16m subframe starts.

For instance, if a subframe indicator is two bits and a subframe indicator within subframe 1 of a position where a 16m subframe starts is set to a value of ‘00’, this indicates that the number of 16m subframes among the following subframes is equal to ‘0’, that is, indicates that the following subframe is a 16e subframe. If the subframe indicator within subframe 1 of the position where the 16m subframe starts is set to a value of ‘01’, this indicates that the number of 16m subframes in the following subframe is equal to ‘1’, that is, indicates that the following one subframe is a 16m subframe and a subsequent following subframe is a 16e subframe. As in FIG. 2, if the subframe indicator within subframe 1 of the position where the 16m subframe starts is set to a value of ‘10’, this indicates that the number of 16m subframes among the following subframes is equal to ‘2’, that is, indicates that the following two subframes (i.e., subframe 2 and subframe 3) are 16m subframes and a subsequent following subframe is a 16e subframe.

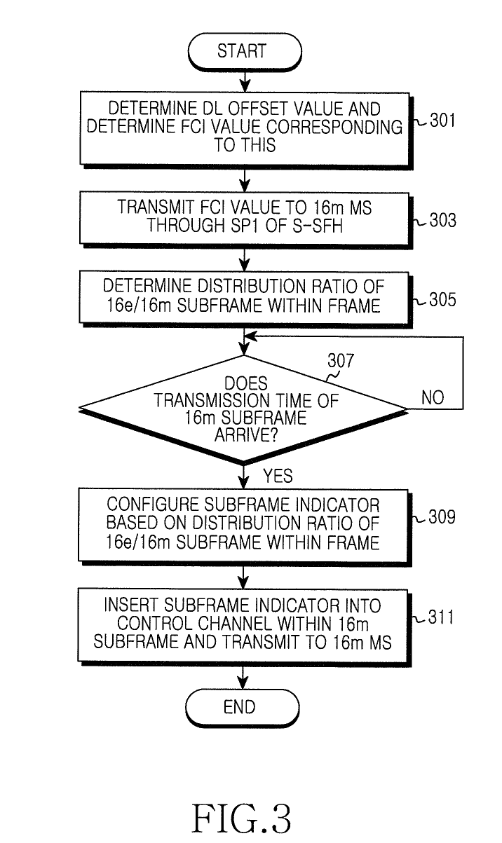

FIG. 3 is a flowchart illustrating an operation method of a BS in which the BS dynamically divides a 16e subframe and a 16m subframe and provides an MS with information on a frame configuration that is changed according to the dynamic division, in a frame structure that supports the coexistence of a 16e communication system and a 16m communication system according to the present invention.

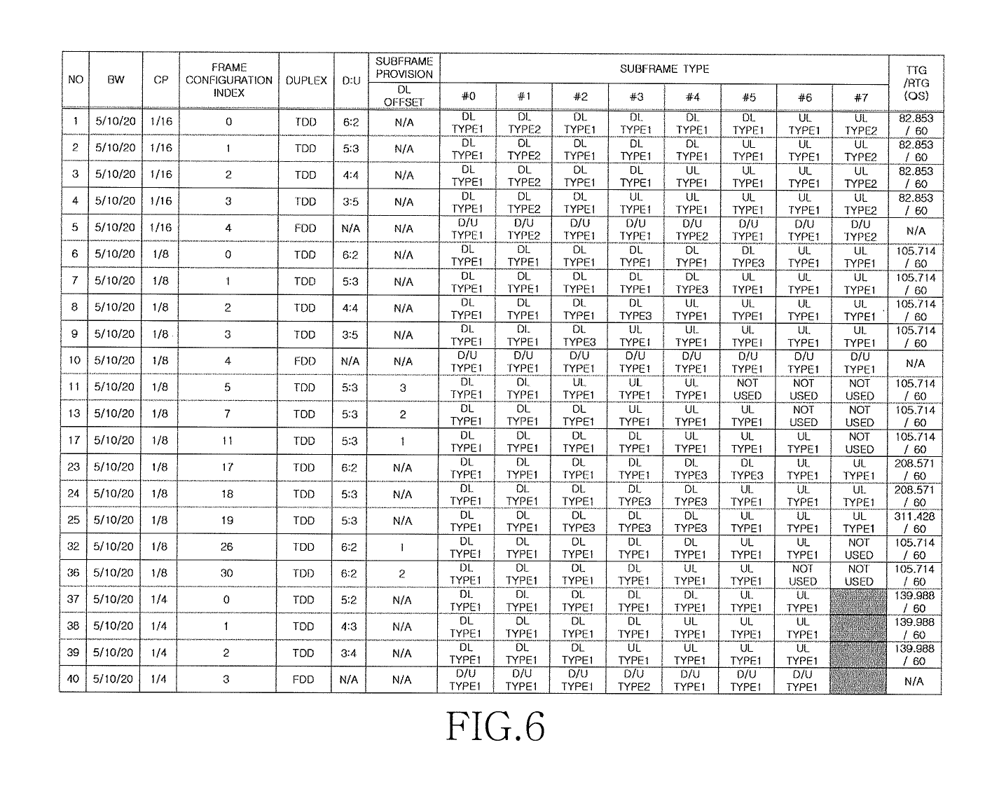

Referring to FIG. 3, in block 301, the BS determines a DL Offset value considering a start position of a 16m subframe to be allocated to a 16m MS within a frame, and determines an FCI value corresponding to the determined DL Offset value, based on a frame configuration and indexing table. Here, the frame configuration and indexing table defines a subframe ratio (D:U) between DL/UpLink (UL) that is mapped to an FCI value, a BandWidth (BW) of the BS, a Cyclic Prefix (CP) length and the like, a DL Offset value representing a start position of a 16m subframe and the like. The frame configuration and indexing table can be, for example, configured as in FIG. 6.

After that, in block 303, the BS transmits the determined FCI value to a 16m MS through an SP1 of an S-SFH.

Next, in block 305, the BS performs scheduling in a frame unit to determine a distribution ratio of 16e/16m subframes within a frame.

After that, in block 307, the BS determines if a transmission time of a 16m subframe arrives. That is, the BS determines if it is a start position of a 16m subframe within a frame.

When it is determined in block 307 that the transmission time of the 16m subframe arrives, in block 309, the BS configures a subframe indicator that indicates to a 16m MS if the following one subframe is a 16m subframe or the number of 16m subframes among the following subframes, based on the determined distribution ratio of 16e/16m subframes within the frame.

Here, the subframe indicator can be configured with one bit to inform a 16m MS if the following one subframe is a 16m subframe. For example, in an embodiment where the following one subframe also is a 16m subframe, the BS can set a subframe indicator within a current 16m subframe to a value of ‘1’ and, in an embodiment where the following one subframe is, from then, not a 16m subframe (i.e., is a 16e subframe), the BS can set a subframe indicator within a current 16m subframe to a value of ‘0’. In this situation, the BS should configure a subframe indicator of one bit for all 16m subframes.

Or, in a different method, the subframe indicator can be configured with ‘N’ bits (e.g., more than one bit) to inform a 16m MS of the number of 16m subframes among the following subframes. For example, in an embodiment where a subframe indicator is of two bits and the number of 16m subframes among the following subframes is equal to two, the BS can set a subframe indicator within a 16m subframe to a value of ‘10’. In this situation, the BS may configure a subframe indicator of ‘N’ bits only for one 16m subframe transmitted in a start position of a 16m subframe within a frame.

Next, in block 311, the BS inserts the configured subframe indicator into a control channel (i.e., A-MAP) within a corresponding 16m subframe, and transmits the 16m subframe into which the subframe indicator is inserted, to a 16m MS.

After that, the BS terminates the algorithm according to the present invention.

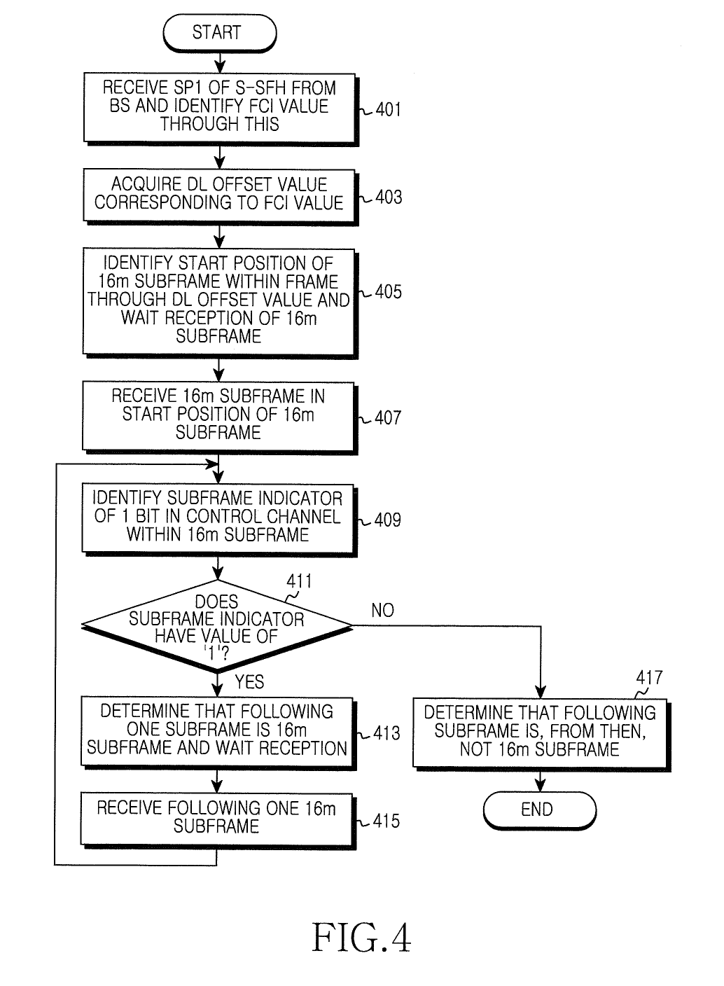

FIG. 4 is a flowchart illustrating an operation method of a 16m MS in which a BS dynamically divides a 16e subframe and a 16m subframe and provides the 16m MS with information on a frame configuration that is changed according to the dynamic division, in a frame structure that supports the coexistence of a 16e communication system and a 16m communication system according to a first embodiment of the present invention.

Referring to FIG. 4, in block 401, the 16m. MS receives an SP1 of an S-SFH from a BS, and identifies an FCI value through the received SP1.

Next, in block 403, the 16m MS acquires a DL Offset value corresponding to the identified FCI value, based on a frame configuration and indexing table.

After that, in block 405, the 16m MS identifies a start position of a 16m subframe to be allocated to the 16m MS within a frame through the acquired DL Offset value, and waits for reception of a 16m subframe until the identified start position of the 16m subframe within the frame.

Next, in block 407, the 16m MS receives the 16m subframe in the identified start position of the 16m subframe within the frame.

After that, in block 409, the 16m MS identifies a subframe indicator of one bit in a control channel (i.e., A-MAP) within the received 16m subframe.

Next, in block 411, the 16m MS determines if the identified subframe indicator with one bit within the 16m subframe has a value of ‘1’.

When it is determined in block 411 that the identified subframe indicator with one bit within the 16m subframe has the value of ‘1’, in block 413, the 16m MS determines that the following one subframe also is a 16m subframe, waits for reception of the following one 16m subframe and then proceeds to block 415.

After that, in block 415, the 16m MS receives the following one 16m subframe and then returns to block 409 and repeatedly performs the subsequent blocks.

Alternatively, when it is determined in block 411 that the subframe indicator with one bit within the identified 16m subframe has a value of ‘0’, in block 417, the 16m MS determines that the following subframe is not a 16m subframe (i.e., determines that the following subframe is a 16e subframe), and finishes downlink reception in a corresponding frame.

Next, the 16m MS terminates the algorithm according to the present invention.

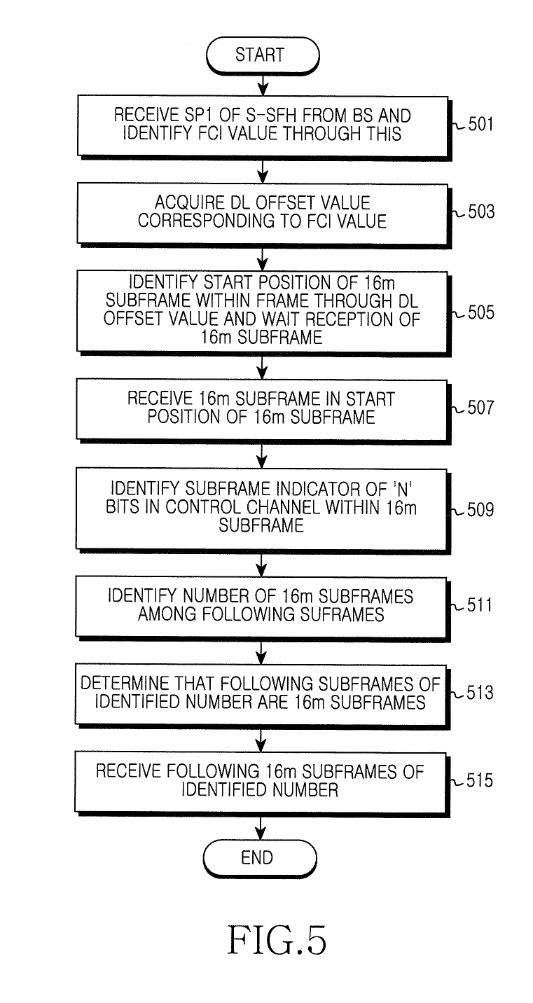

FIG. 5 is a flowchart illustrating an operation method of a 16m MS in which a BS dynamically divides a 16e subframe and a 16m subframe and provides the 16m MS with information on a frame configuration that is changed according to the dynamic division, in a frame structure that supports the coexistence of a 16e communication system and a 16m communication system according to a second embodiment of the present invention.

Referring to FIG. 5, in block 501, the 16m MS receives an SP1 of an S-SFH from a BS, and identifies an FCI value through the received SP1.

Next, in block 503, the 16m MS acquires a DL Offset value corresponding to the identified FCI value, based on a frame configuration and indexing table.

After that, in block 505, the 16m MS identifies a start position of a 16m subframe to be allocated to the 16m MS within a frame through the acquired DL Offset value, and waits for reception of a 16m subframe until the identified start position of the 16m subframe within the frame.

Next, in block 507, the 16m MS receives the 16m subframe in the identified start position of the 16m subframe within the frame.

After that, in block 509, the 16m MS identifies a subframe indicator with ‘N’ bits (e.g., more than one bit) in a control channel (i.e., A-MAP) within the received 16m subframe.

Next, in block 511, the 16m MS identifies the number of 16m subframes among the following subframes, based on the identified subframe indicator with ‘N’ bits (e.g., more than one bit) within the 16m subframe.

After that, in block 513, the 16m MS determines that the following subframes of the identified number are 16m subframes and a subsequent following subframe is a 16e subframe. And then, in block 515, the 16m MS receives the following 16m subframes of the identified number and then finishes downlink reception in a corresponding frame.

Next, the 16m MS terminates the algorithm according to the present invention.

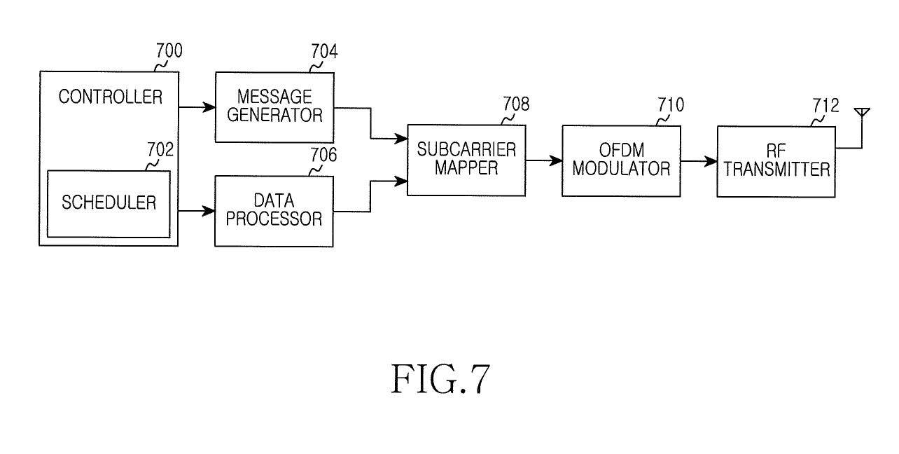

FIG. 7 is a block diagram illustrating an apparatus of a BS in a communication system according to the present invention.

As illustrated, the BS includes a controller 700, a message generator 704, a data processor 706, a subcarrier mapper 708, an Orthogonal Frequency Division Multiplexing (OFDM) modulator 710, and a Radio Frequency (RF) transmitter 712. The controller 700 includes a scheduler 702.

Referring to FIG. 7, the controller 700 controls the general function of the BS. For example, the controller 700 controls the subcarrier mapper 708 to map data signals by 16e/16m MSs according to the resource allocation result. Also, the controller 700 provides information included in a transmit message to the message generator 704.

The scheduler 702 of the controller 700 allocates resources (i.e., 16e/16m subframes) to 16e/16m MSs. Particularly, according to the present invention, the scheduler 702 determines a DL Offset value considering a start position of a 16m subframe to be allocated to the 16m MS within a frame, determines an FCI value corresponding to the determined DL Offset value based on a frame configuration and indexing table, and then provides the determined FCI value to the message generator 704. The message generator 704 generates an SP1 of an S-SFH including the determined FCI value, and provides the generated SP1 of the S-SFH to the subcarrier mapper 708. The subcarrier mapper 708 maps the SP1 including the FCI value to a subcarrier such that the SP1 including the FCI value can be transmitted at transmission time of the S-SFH within a frame.

Also, the scheduler 702 performs scheduling in a frame unit to determine a distribution ratio of 16e/16m subframes within a frame. If a transmission time of a 16m subframe arrives, the scheduler 702 configures a subframe indicator to indicates to a 16m MS if the following one subframe is a 16m subframe or the number of 16m subframes among the following subframes, based on the determined distribution ratio of 16e/16m subframes within the frame, and provides the configured subframe indicator to the message generator 704. Here, the subframe indicator can be configured with one bit to inform a 16m MS if the following one subframe is a 16m subframe. Or, in a different method, the subframe indicator can be configured with ‘N’ bits (e.g., more than one bit) to inform a 16m MS of the number of 16m subframes among the following subframes. The message generator 704 generates an A-MAP Information Element (IE) including the configured subframe indicator, and provides the A-MAP IE to the subcarrier mapper 708. The subcarrier mapper 708 maps the generated A-MAP IE to a subcarrier such that the generated A-MAP IE can be transmitted within a corresponding 16m subframe.

The message generator 704 configures a message bit stream including information provided from the controller 700, and generates physical message signals from the message bit stream to provide the generated physical message signals to the subcarrier mapper 708.

The data processor 706 channel encodes and modulates a transmit data bit stream, thereby generating transmit data signals.

The subcarrier mapper 708 maps data signals provided from the data processor 706 and message signals provided from the message generator 704, to a subcarrier.

The OFDM modulator 710 converts the signals mapped to the subcarrier into a time domain signal through Inverse Fast Fourier Transform (IFFT) operation and inserts a CP, thereby configuring OFDM symbols.

The RF transmitter 712 up-converts the OFDM symbols into an RF band signal and then transmits the RF band signal through an antenna.

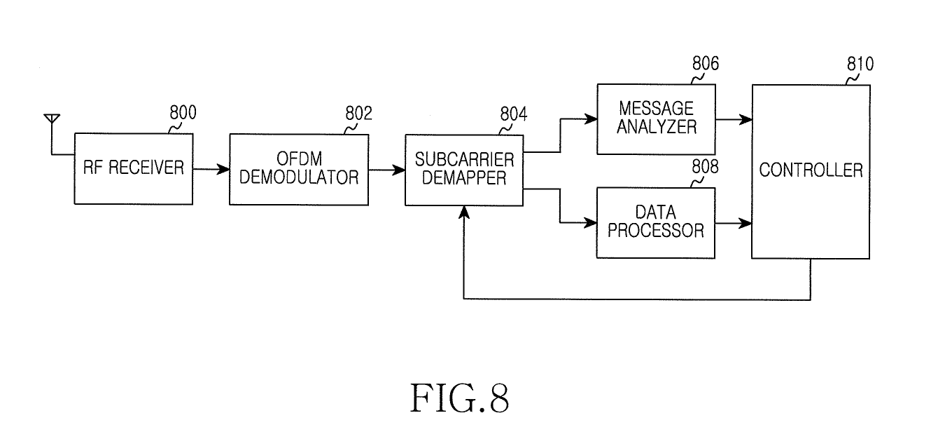

FIG. 8 is a block diagram illustrating an apparatus of a 16m MS in a communication system according to the present invention.

As illustrated, the 16m MS includes an RF receiver 800, an OFDM demodulator 802, a subcarrier demapper 804, a message analyzer 806, a data processor 808, and a controller 810.

Referring to FIG. 8, the RF receiver 800 converts an RF band signal received through an antenna into a baseband signal.

The OFDM demodulator 802 divides the baseband signal in an OFDM symbol unit, eliminates a CP, and then restores signals by subcarrier through Fast Fourier Transform (FFT) operation.

The subcarrier demapper 804 distinguishes the signals by subcarrier in a processing unit, provides message signals to the message analyzer 806, and provides data signals to the data processor 808. In particular, the subcarrier demapper 804 provides an SP1 of an S-SFH within a frame to the message analyzer 806. The message analyzer 806 identifies an FCI value through the SP1 of the S-SFH, and provides the identified FCI value to the controller 810. The controller 810 acquires a DL Offset value corresponding to the identified FCI value based on a frame configuration and indexing table, identifies a start position of a 16m subframe to be allocated to the 16m MS within a frame through the acquired DL Offset value, and instructs the subcarrier demapper 804 to wait for reception of a 16m subframe until the identified start position of the 16m subframe within the frame. In waiting for the reception of the 16m subframe, the subcarrier demapper 804 receives the 16m subframe in the identified start position of the 16m subframe within the frame, and provides an A-MAP IE within the received 16m subframe to the message analyzer 806. The message analyzer 806 identifies a subframe indicator within the A-MAP IE of the 16m subframe and provides the identified subframe indicator to the controller 810. The controller 810 identifies if the following one subframe is a 16m subframe or a number of 16m subframes among the following subframes, based on the identified subframe indicator, and controls the subcarrier demapper 804 to receive the following 16m subframe according to the identification result. Here, the subframe indicator can be configured with one bit to inform a 16m MS if the following one subframe is a 16m subframe. Or, in a different method, the subframe indicator can be configured with ‘N’ bits (e.g., more than one bit) to inform a 16m MS of the number of 16m subframes among the following subframes.

The message analyzer 806 restores a message bit stream from message signals received from a BS. The message analyzer 806 analyzes the restored message bit stream, thereby identifying information included in the message bit stream, and provides the identified information to the controller 810.

The data processor 808 demodulates and channel decodes the data signals, thereby restoring a data reception bit stream.

The controller 810 controls the general function of the 16m MS. For example, the controller 810 controls the subcarrier demapper 804 to extract data signals from allocated resources identified by the message analyzer 806.

A region of transmission of a subframe indicator according to the present disclosure can be defined as follows.

First, the subframe indicator proposed in the present invention can be transmitted through any control signal already defined in the existing 16m standard.

For one embodiment, a reserved one bit of a non-user specific A-MAP IE is utilized within a corresponding subframe. In this situation, since the reserved bit can be ensured only one bit, it can be used in an embodiment in which a subframe indicator of one bit for indicating if the following one subframe is a 16m subframe is inserted into all 16m subframes as in FIG. 1 above.

For another embodiment, multiple reserved bits of a Broadcast Assignment A-MAP IE are utilized within a corresponding subframe. In this situation, since the reserved bits include more than one bit, the reserved bits can be used not only in an embodiment in which a one-bit subframe indicator that indicates if the following one subframe is a 16m subframe is inserted into all 16m subframes as in FIG. 1 above, but also it can be used in an embodiment in which a subframe indicator of ‘N’ bits (e.g., more than one bit) that indicates the number of 16m subframes among the following subframes is inserted into a 16m subframe of a position where the 16m subframe starts as in FIG. 2 above. So, in an embodiment where a subframe indicator transmitted through a Broadcast Assignment A-MAP IE within a frame is of one bit, this can represent the application of the embodiment that indicates if the following one subframe is a 16m subframe and, in an embodiment where the subframe indicator transmitted through the Broadcast Assignment A-MAP IE within the frame is of any ‘N’ bits greater than one, this can represent the application of the embodiment that indicates the number of 16m subframes among the following subframes.

Secondly, apart from a control signal already defined in the existing 16m standard, a subframe indication A-MAP IE for a subframe indicator is newly defined and, through this, the subframe indicator proposed in the present invention can be transmitted. Embodiments of the present disclosure can use an existing reserved A-MAP IE to newly define the subframe indication A-MAP IE for the subframe indicator, for example, as defined as in Table 1 below.

TABLE 1

| Syntax | Size[bits] | Notes |
|---|---|---|
| Subframe Indication | | |
| A-MAP IE ( ){ | | |
| A-MAP IE Type | 4 | |
| Sub-Frame | N | (Embodiment 1) if N = 1, |
| Indicator | | ‘0’: end of 16 m subframe |
| | | ‘1’: maintenance of 16 m subframe |
| | | (Embodiment 2) if N > 1, |
| | | maintenance of 16 m subframe |
| | | during the constant number of |
| | | following subframes |
| } | | |

In this situation, as in Table 1 above, it can be used not only in an embodiment in which a one-bit subframe indicator that indicates if the following one subframe is a 16m subframe is inserted into all 16m subframes as in FIG. 1 above, but also it can be used in an embodiment in which a subframe indicator of ‘N’ bits (e.g., more than one bit) that indicates the number of 16m subframes among the following subframes is inserted into a 16m subframe of a position where the 16m subframe starts as in FIG. 2 above. So, in an embodiment where a subframe indicator transmitted through a newly defined Subframe Indication A-MAP IE within a frame is one bit, this can represent the application of the embodiment that indicates if the following one subframe is a 16m subframe and, in an embodiment where the subframe indicator transmitted through the newly defined Subframe Indication A-MAP IE within the frame is ‘N’ bits, this can represent the application of the embodiment that indicates the number of 16m subframes among the following subframes.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An operation method of a Base Station (BS) for dynamically allocating resources in a network associated with a first communication system and a second communication system, the method comprising:
in a start position of a subframe within a frame of the second communication system, generating information on a following subframe for the second communication system's subframe existing in the start position, in a frame structure that supports the coexistence of the first communication system and the second communication system; and
inserting the generated information on the following subframe into a control signal transmitted through a predefined region within the second communication system's subframe existing in the start position, and transmitting the control signal to a mobile station (MS) associated with the second communication system.

2. The method of claim 1, further comprising dynamically determining a distribution ratio of a first communication system's subframe and the second communication system's subframe within the frame.

3. The method of claim 1, wherein the information on the following subframe is a subframe indicator comprising one bit and is information that indicates if the following one subframe is the second communication system's subframe.

4. The method of claim 1, wherein the information on the following subframe is a subframe indicator comprising more than one bit and is information that indicates the number of second communication system's subframes among the following subframes.

5. The method of claim 1, further comprising:
determining a downlink (DL) offset value considering the start position of the second communication system's subframe to be allocated to the second communication system's MS within the frame;
determining a frame configuration index (FCI) value corresponding to the determined DL offset value; and
transmitting the determined FCI value to the second communication system's MS through a subpacket1 (SP1) of a secondary-super frame header (S-SFH).

6. The method of claim 1, wherein the control signal transmitted through the predefined region is a non-user specific advanced-MAP information element (A-MAP IE) or a broadcast assignment A-MAP IE.

7. The method of claim 1, wherein the first communication system is an Institute of Electrical and Electronics Engineers (IEEE) 802.16e communication system, and the second communication system is an IEEE 802.16m communication system.

8. An operation method of a second communication system's mobile station (MS) configured to receive dynamic allocation of resources in a network associated with a first communication system and a second communication system, the method comprising:
receiving a second communication system's subframe existing in a start position of a second communication system's subframe within a frame, in a frame structure that supports the coexistence of the first communication system and the second communication system; and
extracting information on the following subframe from a control signal transmitted through a defined region within the received second communication system's subframe.

9. The method of claim 8, wherein a distribution ratio of a first communication system's subframe and the second communication system's subframe within a frame is dynamically determined by a base station (BS).

10. The method of claim 8, wherein the information on the following subframe is a subframe indicator comprising one bit and is information that indicates if the following one subframe is the second communication system's subframe.

11. The method of claim 10, further comprising:
determining if the subframe indicator comprising one bit has a value of ‘1’;
when the subframe indicator comprising one bit has the value of ‘1’, determining that the following one subframe is the second communication system's subframe, and receiving the following one second communication system's subframe; and
when the subframe indicator comprising one bit has a value of ‘0’, determining that the following subframe is the first communication system's subframe, and finishing downlink reception in a corresponding frame.

12. The method of claim 8, wherein the information on the following subframe is a subframe indicator comprising more than one bit and is information that indicates the number of the second communication system's subframes among the following subframes.

13. The method of claim 12, further comprising:
identifying the number of the second communication system's subframes among the following subframes, through the subframe indicator comprising more than one bit;
determining that the following subframes of the identified number are the second communication system's subframes, and a subsequent following subframe is the first communication system's subframe; and
after receiving the following second communication system's subframes of the identified number, finishing downlink reception in a corresponding frame.

14. The method of claim 8, further comprising:
receiving a subpacket1 (SP1) of a secondary-super frame header (S-SFH) from a BS;
identifying a frame configuration index (FCI) value through the received SP1, and acquiring a downlink (DL) offset value corresponding to the identified FCI value;
identifying a start position of the second communication system's subframe to be allocated to the second communication system's mobile station (MS) within a frame through the acquired DL offset value; and
until the identified start position of the second communication system's subframe within the frame, waiting to receive a second communication system's subframe.

15. The method of claim 8, wherein the control signal transmitted through the predefined region is a non-user specific advanced-MAP information element (A-MAP IE) or a broadcast assignment A-MAP IE.

16. The method of claim 8, wherein the first communication system is an Institute of Electrical and Electronics Engineers (IEEE) 802.16e communication system, and the second communication system is an IEEE 802.16m communication system.

17. An apparatus of a Base Station (BS) for dynamically allocating resources in a network associated with a first communication system and a second communication system, the apparatus comprising:
a scheduler configured, in a start position of a subframe within a frame of the second communication system, to generate information on a following subframe for the second communication system's subframe existing in the start position, in a frame structure that supports the coexistence of the first communication system and the second communication system;
a message generator configured to insert the generated information on the following subframe into a control signal transmitted through a predefined region within the second communication system's subframe existing in the start position; and
a Radio Frequency (RF) transmitter configured to transmit the control signal into which the information on the following subframe is inserted, to a Mobile Station (MS) associated with the second communication system.

18. The apparatus of claim 17, wherein the scheduler dynamically determines a distribution ratio of a first communication system's subframe and the second communication system's subframe within a frame.

19. The apparatus of claim 17, wherein the information on the following subframe is a subframe indicator comprising one bit and is information that indicates if the following one subframe is the second communication system's subframe.

20. The apparatus of claim 17, wherein the information on the following subframe is a subframe indicator comprising more than one bit and is information that indicates the number of second communication system's subframes among the following subframes.

21. The apparatus of claim 17, wherein the scheduler determines a downlink (DL) offset value considering the start position of the second communication system's subframe to be allocated to the second communication system's MS within the frame, and determines a frame configuration index (FCI) value corresponding to the determined DL offset value, and
the RF transmitter transmits the determined FCI value to the second communication system's MS through a subpacket1 (SP1) of a secondary-super frame header (S-SFH).

22. The apparatus of claim 17, wherein the control signal transmitted through the predefined region is a non-user specific advanced-MAP information element (A-MAP IE) or a broadcast assignment A-MAP IE.

23. The apparatus of claim 17, wherein the first communication system is an Institute of Electrical and Electronics Engineers (IEEE) 802.16e communication system, and the second communication system is an IEEE 802.16m communication system.

24. An apparatus of a second communication system's mobile station (MS) for receiving dynamic allocation of resources in a network associated with a first communication system and the second communication system, the apparatus comprising:
a radio frequency (RF) receiver configured to receive a subframe of the second communication system existing in a start position of a subframe within a frame of the second communication system, in a frame structure that supports the coexistence of the first communication system and the second communication system; and
a message analyzer configured to extract information on the following subframe from a control signal transmitted through a defined region within the received second communication system's subframe.

25. The apparatus of claim 24, wherein a distribution ratio of a first communication system's subframe and the second communication system's subframe within a frame is dynamically determined by a base station (BS).

26. The apparatus of claim 24, wherein the information on the following subframe is a subframe indicator comprising one bit and is information that indicates if the following one subframe is the second communication system's subframe.

27. The apparatus of claim 26, further comprising a controller configured to:
determine if the subframe indicator comprising one bit has a value of ‘1’;
when the subframe indicator comprising one bit has the value of ‘1’, determine that the following one subframe is the second communication system's subframe and receive the following one second communication system's subframe through the RF receiver; and
when the subframe indicator comprising one bit has a value of ‘0’, determine that the following subframe is the first communication system's subframe, and finish downlink reception in a corresponding frame.

28. The apparatus of claim 28, wherein the information on the following subframe is a subframe indicator comprising more than one bit and is information that indicates the number of the second communication system's subframes among the following subframes.

29. The apparatus of claim 28, further comprising a controller configured to:
identify the number of the second communication system's subframes among the following subframes through the subframe indicator of more than one bit;
determine that the following subframes of the identified number are the second communication system's subframes and a subsequent following subframe is the first communication system's subframe; and
after receiving the following second communication system's subframes of the identified number through the RF receiver, finish downlink reception in a corresponding frame.

30. The apparatus of claim 24, further comprising a controller configured to:
acquire a downlink (DL) offset value corresponding to a frame configuration index (FCI) value identified through a subpacket1 (SP1) of a secondary-super frame header (S-SFH);
identify a start position of the second communication system's subframe to be allocated to a Mobile Station (MS) of the second communication system within a frame through the acquired DL offset value; and
until the identified start position of the second communication system's subframe within the frame, wait to receive the second communication system's subframe,
wherein the RF receiver receives the SP1 of the S-SFH from a BS, and
wherein the message analyzer identifies the FCI value through the received SP1.

31. The apparatus of claim 24, wherein the control signal transmitted through the predefined region is a non-user specific advanced-MAP information element (A-MAP IE) or a broadcast assignment A-MAP IE.

32. The apparatus of claim 24, wherein the first communication system is an Institute of Electrical and Electronics Engineers (IEEE) 802.16e communication system, and the second communication system is an IEEE 802.16m communication system.
